(19) United States
(12) Patent Application Publication
(10) Pub. No.: US 2009/0134309 A1
(43) Pub. Date: May 28, 2009

(54) CHIP FOR ANALYZING A MEDIUM COMPRISING AN INTEGRATED ORGANIC LIGHT EMITTER

(75) Inventors: Karl LEO, Dresden (DE); Uwe VOGEL, Dresden (DE)

Correspondence Address: SCHOPPE, ZIMMERMANN , STOCKELER & ZINKLER;C/O KEATING & BENNETT, LLP, 1800 Alexander Bell Drive, SUITE 200, Reston, VA, 20191, US

(73) Assignee: Fraunhofer-Gesellschaft zur foerderung der angewandten Forschung e.V., Munich (DE)

(21) Appl. No.: 12/275,327

(22) Filed: Nov. 21, 2008

(30) Foreign Application Priority Data
Nov. 22, 2007 (DE) 102007056275.8

(51) Int. Cl. G01J 1/20

(52) U.S. Cl. 250/201.1

(57) ABSTRACT

A chip for analyzing a medium includes an organic light emitter for emitting a light signal, a photodetector including a detector area, a layer sequence separating the organic light emitter and the detector area, and a reservoir into which the medium may be introduced. The organic light emitter and the photodetector are optically couplable by means of a path of rays of the light signal, and the reservoir is arranged within the path of rays of the light signal.

### CROSS-REFERENCE TO RELATED APPLICATIONS:

This application claims priority from German Patent Application No. 102007056275.8, which was filed on Nov. 22, 2007, and is incorporated herein by reference in its entirety.

The present invention relates to a chip for analyzing a medium comprising an integrated organic light emitter, and in particular to a monolithically integrated lab-on-chip device comprising an OLED light source (OLED=organic light-emitting diode).

### BACKGROUND OF THE INVENTION

Nowadays, microarrays are widely used in medical diagnostics. They comprise, for example, realizing a grid-shaped arrangement (array or matrix arrangement) of small containers or pots, into which biologically active substances (the medium) may be introduced, on a surface. For example, the array may be wetted or covered with a serum such as blood, so that it is possible to examine how sought-for substances from the serum are fixed within the various pots of the array. At the same time, the serum within the different pots may thus be examined in parallel with regard to various constituents. A common evaluation method in this context is an optical one, which comprises exciting the serum (the substance) by an external light source, for example so as to fluoresce, and detecting the fluorescence by an external instrument such as an imaging microscope. To achieve a high level of sensitivity, the arrangement should meet high demands with regard to detectivity and homogeneity. Subsequently, an evaluation of the resulting pattern from the examinations within the various pots of the array may be performed in an external computer.

Hybrid integration of light emitter and light detector, for example in the form of connecting prefabricated devices, in principle entails a large fabrication effort and does not allow general price degression, especially with large numbers of pieces. Furthermore, due to the hybrid structure, a desired level of reliability can only be achieved at extremely high cost.

Light-emitting diodes may be used as the light emitters, conventional light-emitting diodes (LEDs) made of inorganic semiconductors such as GaAs and related III-V semiconductors having been known for decades. The basic principle of such conventional light-emitting diodes is that application of an electric voltage results in electrons and holes being injected into a semiconductor and combining in a radiative manner in a recombination zone while emitting light. Light-emitting diodes based on inorganic semiconductors exhibit significant disadvantages for many applications. Since they are realized on monocrystalline substrates, they can only be applied to III-V semiconductor backgrounds or, if this is not possible, be mounted on an extraneous substrate, which involves a large amount of effort.

Photodiodes as potential light receivers or photodetectors may be mapped, in a standard CMOS process (CMOS=complementary metal oxide semiconductor), at various pn interfaces, and FIG. 8 shows an example in a conventional n well CMOS process. Here, an n-doped region or well (n well) 920 is formed in a p-doped substrate (p substrate) 910, said n-doped region or well comprising a p⁺-doped layer 930 on the side facing away from the p substrate 910. As a final layer for the photodetector, the p substrate 910 comprises an oxide layer 940, which is followed by typical CMOS layers such as an ILD (inter-layer dielectric) layer 950 and an IMD (inter-metal dielectric) layer 960. The oxide layer 940, the ILD layer 950 as well as the IMD layer 960 advantageously comprise a dielectric material and are translucent. The oxide layer 940 may possibly be opaque, at least in some areas. Various pn junctions are characterized by diodes 962, 964 and 975 in FIG. 8.

Within the n well 920, incident light beams 990 create a charge carrier pair 985 having oppositely charged polarities and being separated in accordance with the polarity and causing an electrical signal. The different photodetectors realized by the diodes 962, 964 and 975 may be used selectively or combined, in spectrally different manners in each case. In this context, the diode 962 is formed by the p substrate 910 and the n well 920, and the diode 964 is formed by the n well 920 and a p⁺-doped layer 930. FIG. 8 also shows a photodiode 975 formed of a pn junction from the p substrate 910 and an n⁺-doped surface layer 970. The light signals 980 represent, for example, reflected light at the surface layer 970.

As alternatives to inorganic light-emitting diodes, light-emitting diodes based on organic semiconductors have made great progress in the last few years. Essential advantages of organic electroluminescence include the fact that, due to their chemical variability, organic light-emitting diodes may be produced with virtually any color, and may be applied to most varied substrates due to the deposition at low temperatures.

Organic light-emitting diodes mostly comprise an organic layer sequence between an anode and a cathode, it being possible for the organic layer sequence to comprise a layer thickness of about 100 nm, for example. Glass is commonly used as the substrate, onto which a transparent, conducting oxide layer is applied which may comprise indium tin oxide (ITO), for example. This is mostly followed by an organic layer sequence which may comprise a hole-transporting material, an emitting material and an electron-transporting material. Finally, a metallic cathode is applied in most cases.

In general, one distinguishes between organic light-emitting diodes (OLEDs) as top emitters and OLEDs as bottom emitters. Typically, bottom emitters emit the light signal mainly through the substrate, whereas top emitters emit in a direction away from the substrate.

FIG. 9 shows an organic light-emitting diode (OLED) 905 configured as a top emitter. Here, a substrate 915 has an electrode 925, an organic layer sequence 935 and a transparent electrode 945 applied to it. Contacting is effected via a connection 955 to the electrode 925 as well as via a connection 965 to the transparent electrode 945. The substrate 915 mostly comprises a non-transparent material, and the electrode 925 comprises a metal, for example. This results in the fact that upon application of a corresponding voltage at the connections 955 and 965 a light signal 944 generated within the organic layer sequence 935 is emitted upward through the transparent electrode 945 (for example made of ITO) in the type of illustration shown.

Known approaches to analyzers are described, for example in U.S. Pat. No. 6,331,438 B1, US 2003/0035755 A1, WO 2005/103652 A1, WO 2005/108963 A1, and U.S. Pat. No. 7,170,605 B2. In U.S. Pat. No. 6,331,438 B1, integration of an analytically sensitive layer with a thin-film electroluminescent layer and a photodetector in the form of an array is described, which array is suitable for examining biological, chemical or physical analytes. The substrate materials proposed in said patent specification, however, do not allow any integration of active electronic elements for signal processing on the chip. US 2003/0035755 A1 discloses a biochip utilizing an organic electroluminescence device, the electroluminescent light-emitting device serving as a substrate comprising a light source or heating for the biochip. WO 2005/103652 A1 discloses an optoelectronic biochip, both the light emitter and the photodetector being monolithically integrated on a chip. In this context, propagation of light takes place from the light emitter in the direction opposite to the propagation of light to the photodetector. WO 2005/108963 A1 discloses a microfluidic cell sorting system implemented to separate, to clean and to count cell subcultures, optical analysis being utilized for detection. In U.S. Pat. No. 7,170,605 B2, an active sensor array for DNA analysis is described which represents a plurality of integrated light sources and photodetectors for sample analysis. Said patent application also discloses the possibility of introducing filters into the optical path and of controlling the individual light sources of the array. Evaluation of the respective signals may be performed by a control unit.

Conventional analyzers are disadvantageous in that they either use conventional LEDs based on III-V semiconductors, and accordingly are mostly manufactured as a hybrid design. In principle, this hybrid design entails a greater fabrication effort and, associated therewith, higher manufacturing cost. In addition, a hybrid design frequently is a source of defects or malfunctions (lack of reliability), which limits, in particular, the service life of the device.

### SUMMARY

According to an embodiment, a chip for analyzing a medium may have: an organic light emitter for emitting a light signal; a photodetector including a detector area; a layer sequence separating the organic light emitter and the detector area, the layer sequence including a dielectric layer of a CMOS structure and serving as a substrate for the organic light emitter; and a reservoir into which the medium may be introduced and which is implemented as a channel within the layer sequence, wherein the organic light emitter and the photodetector may be optically coupled by means of a path of rays of the light signal, and the reservoir is arranged within the path of rays of the light signal.

According to another embodiment, utilization of a chip for analyzing a medium which has: an organic light emitter for emitting a light signal; a photodetector including a detector area; a layer sequence separating the organic light emitter and the detector area, the layer sequence including a dielectric layer of a CMOS structure and serving as a substrate for the organic light emitter; and a reservoir into which the medium may be introduced and which is implemented as a channel within the layer sequence, wherein the organic light emitter and the photodetector may be optically coupled by means of a path of rays of the light signal, and the reservoir is arranged within the path of rays of the light signal, may be as a lab-on-chip sensor, as a fluorescence sensor, or as a spectral sensor.

According to another embodiment, a method of manufacturing a chip for analyzing a medium may have the steps of: implementing a photodetector including a detector area; implementing a layer sequence on the detector area of the photodetector, the layer sequence including a dielectric layer of a CMOS structure; implementing an organic light emitter for emitting a light signal, the layer sequence serving as a substrate for the organic light emitter, and the layer sequence being arranged between the organic light emitter and the detector area; and implementing a reservoir into which the medium may be introduced and which is implemented as a channel within the layer sequence, the organic light emitter and the photodetector being implemented such that a path of rays of the light signal optically couples the organic light emitter and the photodetector, and the reservoir being implemented within the path of rays of the light signal.

The present invention is based on the finding that, by integrating an OLED emitter onto a largely structured CMOS substrate, monolithic integration of a light source and of a photodetector on a chip is possible. Integration of the OLED may be performed in a final process or by means of so-called post-processing. Structures of the CMOS layout may act as an electric isolator and light guide at the same time. Photodiodes, phototransistors or similar elements which form at pn barrier layers and are thus CMOS-inherent are used as the photodetector.

Embodiments of the present invention thus describe a chip for analyzing a medium, the chip comprising an organic light emitter, a photodetector, a layer sequence and a reservoir. The organic light emitter emits a light signal which may enter the photodetector by a detector area of the photodetector. The layer sequence separates the organic light emitter and the detector area, and the medium may be introduced into the reservoir. The organic light emitter and the photodetector may thus be optically coupled by means of a path of rays of the light signal, the reservoir being arranged within the path of rays of the light signal.

For example, the photodetector may be implemented (e.g. in the form of a pn junction) within a substrate comprising silicon. The combination of silicon substrates with organic devices enables performing the functions which are described for lab-on chips in an integrated manner. For example, this comprises the following three items:

Firstly, spectrally sensitive detectors which are able to directly detect the various fluorescence dyes without any further use of filters may be integrated into the silicon. This enables the signal data to be read out in a particularly simple manner.

Secondly, organic light-emitting diodes may be integrated which achieve very homogenous and uniform illumination and additionally result in highly efficient and simple coupling.

Thirdly, with such a kind of structure, processing of the signals from the medium may be effected directly with a circuit on the silicon substrate, so that no further external logic (or circuit) becomes necessary. Thus, it is possible in particular to conduct a perfectly autonomous evaluation of such data on a single chip, as a result of which external, expensive instruments may be dispensed with, on the one hand, and there is a possibility, on the other hand, for example to hand out such an instrument to a patient directly and possibly to use it as a disposable system.

In further embodiments, a similar functionality may also be achieved by using other semiconductor materials.

In embodiments, for example, the reservoir may be implemented as a reagent reservoir or as a microchannel within the CMOS structure—for example in one of the oxide layers. Optionally, it is further possible that in further embodiments a filter may be arranged between the photodetector and the reservoir, and the variable to be measured by the photodetector may comprise, for example, extinction or absorption of the light signal. In this context, any fluorescence or phosphorescence caused by the irradiation of the medium within the reservoir may be measured, for example. In concrete terms, one may measure either the wavelength or the decay time of the radiation emanating from the medium within the reservoir. Emanating radiation here and below shall not only be taken to mean the radiation generated within the medium, but also radiation which is reflected by the medium or through which the medium has passed.

For example, it is possible that the radiation emanating from the medium as a result of the fluorescence/phosphorescence comprises a wavelength different from that of the light generated by the organic light emitter. In such a case, the optional filter may be employed, for example, for filtering out the portion of the original light signal, so that only that light which emanates from the medium as a result of the fluorescence/phosphorescence may enter the photodetector and be detected there. For example, it is possible that irradiating a medium with UV radiation results in that the medium will fluoresce within the visible spectral range. Accordingly, it is not necessary for the OLED to emit visible light. Thus, if the filter filters out any parasitic light, but allows the light to be measured to pass, a marked increase in sensitivity will therefore be possible. In this context, the decay time indicates a time interval during which the intensity of the light signal changes by a predetermined factor (e.g. ½, ¼, 1/10 or 1/e, e=Euler number). The decay time is important, in particular, for differentiating fluorescent and phosphorescent components within the medium, since phosphorescence causes clearly longer (e.g. more than 10 times longer) afterglow of the medium than fluorescence.

In further embodiments, the photodetector comprises an organic photovoltaic cell for photodetection. In addition, embodiments may comprise organic/inorganic materials or layers which have a specific optical filtering effect and may be used, for example, in connection with white OLED as emitters.

Further embodiments describe integration of active electronic elements for signal processing within an area of the substrate within or above which the OLED is formed and may be laterally offset from the photodetector.

In further embodiments, the CMOS photodetector is implemented, by a design or a barrier-layer selection, such that a corresponding spectral filtering effect is achieved, and so that the photodetector therefore is sensitive in particular with regard to a specific spectral range. In further embodiments, a matrix arrangement is selected such that several photodetectors and/or several light emitters are arranged adjacently to one another in a planar manner, so that several studies of the medium (serum) may be performed in parallel at the same time. It is also possible for the reservoir to also contain several areas which may either be interconnected or may also be arranged such that they are adjacent to and separate from one another (in the form of an array).

In further embodiments, in particular absorption spectroscopy is exploited, wherein it is advantageous to irradiate the medium with a white OLED, so that the absorption spectrum may be studied by studying the radiation emanating from the medium.

In further embodiments, the reservoir comprises cavities which may, for example, represent microresonators or are part of a resonator, so that the radiation emanating from the medium is influenced or changed (e.g. with regard to the wavelength, decay time, etc.) by the wave standing within the microresonators.

Thus, embodiments of the present invention offer a number of improvements and advantages over conventional approaches. These advantages comprise, for example, monolithic integration of the light source and of the photodetector onto a CMOS chip, the emitter area of the light source being geometrically patternable in almost any manner desired. Moreover, it is possible to integrate various emitter wavelengths at the same time—for example by adjacently arranged OLEDs comprising different wavelengths. It is also possible to utilize a region below the OLED area or transmitter area (from which the light is emitted) for an active circuit, it being possible for the active circuit to comprise signal and information processing, for example. In this context, it may be advantageous to utilize CMOS-inherent metallizations as shielding planes so as to protect the active circuit from interference effects due to irradiation with light.

Embodiments of the present invention further enable omission of color filters in the spectral selection of the detectors, and thus enable monitoring of the homogeneity of the illumination. Thus, embodiments allow a clear reduction in the chip area, a reduction in external electronics, and a reduction in AVP cost (AVT=Aufbau- und Verbindungstechnik, structural design and coupling technology), and are therefore suitable, for example, for point-of-care diagnosis. Corresponding instruments may be handed out to a patient, for example.

### BRIEF DESCRIPTION OF THE DRAWINGS

Embodiments of the present invention will be detailed subsequently referring to the appended drawings, in which:

FIG. 1 is a cross-sectional view of an analysis chip with an OLED as a bottom emitter and with a photodetector in accordance with an embodiment;

FIG. 2 shows a cross-sectional view of an analysis chip having an optional filter;

FIG. 3 shows a cross-sectional view of an analysis chip, the OLED being designed as a bottom emitter which indirectly radiates onto the photodetector;

FIG. 4 shows a cross-sectional view of an analysis chip, the OLED being designed as a top emitter which indirectly radiates onto the photodetector;

FIG. 5 shows a top view of a potential sensor arrangement for a so-called lab-on-chip application;

FIG. 6 shows a top view of a potential arrangement as a fluorescence sensor;

FIG. 7 shows a top view of a potential arrangement for a spectral or color sensor;

FIG. 8 is a cross-sectional view of a conventional photodiode in the standard n well CMOS process; and

FIG. 9 is a cross-sectional view of a conventional organic light-emitting diode as a top emitter.

### DETAILED DESCRIPTION OF THE INVENTION

Before the present invention will be explained below in more detail on the basis of the drawings, it shall be noted that identical elements in the figures are given identical or similar reference numerals, and that repeated descriptions of these elements shall be dispensed with.

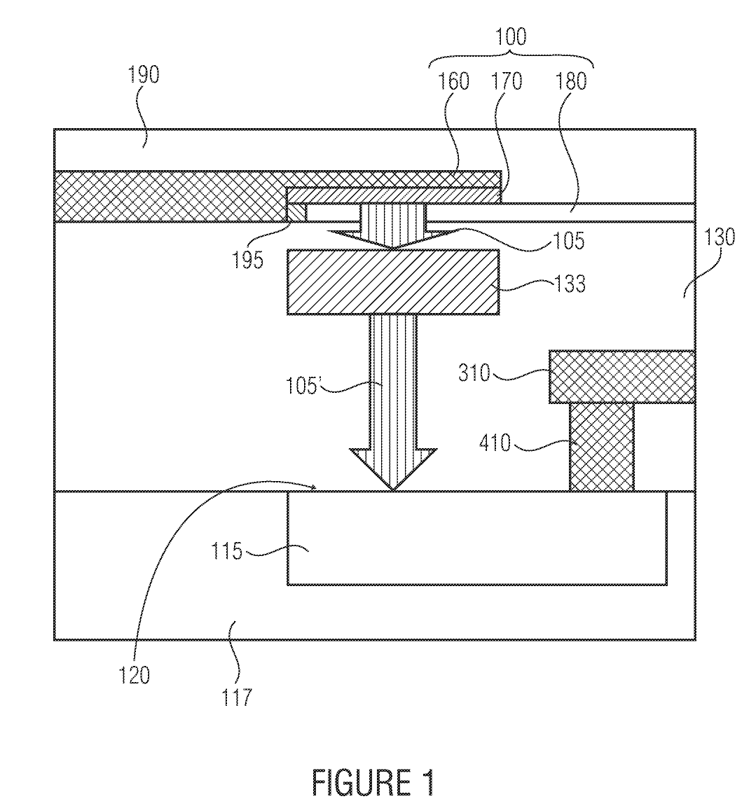

FIG. 1 shows an embodiment in which a photodetector comprises a photodiode 115 which may be formed, for example, by means of a pn junction of an n well to a substrate 117 or to a p⁺-doped surface layer (or which uses any other existing pn junction). The photodiode 115 comprises a detector area 120 and is contacted with a shielding plane 310 via the contact 410. Further contacts of the photodetector are not depicted for simplicity's sake. The photodetector 115 and the OLED 100 are separated by a layer sequence 130 comprising a reservoir 133. The reservoir 133 may be implemented as a reagent reservoir or microchannel, and may serve as a container for the medium (e.g. serum) to be examined. It may thus serve as a sample holder at the same time. The OLED 100 comprises a transparent electrode 180, an organic layer sequence 170, and a second electrode 160, the transparent electrode 180 being deposited on the layer sequence 130, or vice versa. Finally, the chip is protected by a passivation 190. Lateral isolation 195 results in electrical separation of the transparent electrode 180 and the second electrode 160.

A light signal 105 generated by the OLED 100 thus passes the reservoir 133, and the light signal 105′ emanating from the reservoir 133 enters the photodetector 115 via the detector area 120.

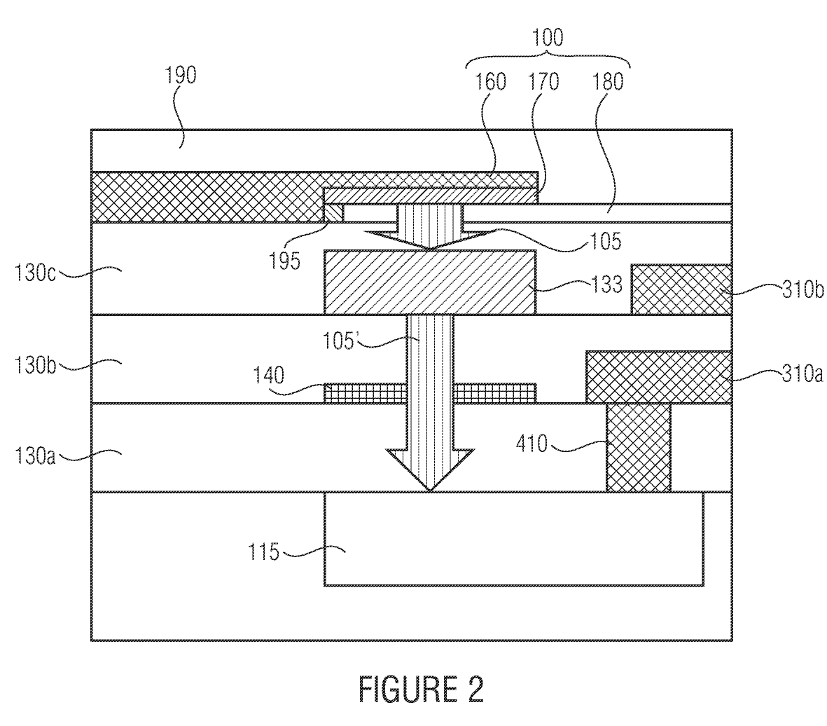

FIG. 2 shows an embodiment which differs from the embodiment shown in FIG. 1 in that, on the one hand, the layer sequence 130 comprises CMOS-typical components, for example an ILD layer 130a (ILD=inter-layer dielectric) is arranged, followed by an IMD1 layer 130b (IMD=inter-metal dielectric) and an IMD2 layer 130c. The IMD1 layer 130b comprises a shielding plane 310a, and the IMD2 layer 130c comprises a shielding plane 310b.

The photodetector 115 is connected to the shielding plane 310a by means of a bridge, or via, 410 which bridges the ILD layer 130a. The shielding plane 310a thus serves to electrically connect the contact 410. The ILD layer 130a serves as a protection for the photodiode 115 and the p substrate 117. The ILD layer 130a, the IMD1 layer 130b and the IMD2 layer 130c in turn are typical components of a CMOS structure, as are the shielding planes 310a and 310b, which may be implemented, for example, by a conductive metal plane of the CMOS structure. The second electrode 160 may also be readily realized by a CMOS metallization. The embodiment shown in FIG. 2 further comprises an optional filter 140 which, in the present case, is implemented in the IMD1 layer 130b, but may also be implemented in other layers.

As the bottom emitter 100, the OLED generates the light signal 105 from an electrical input signal, said light signal 105 passing the IMD2 layer 130c and entering the reservoir 133. The light signal 105′ emanating from the reservoir 133 passes the IMD1 layer 130b, the optional filter 140 and the ILD layer 130a before entering the photodiode 115 and generating an electrical output signal there. As the variable to be measured, the electrical output signal may measure the extinction, absorption, fluorescence, etc. of the light signal 105′ emanating from the reservoir 133.

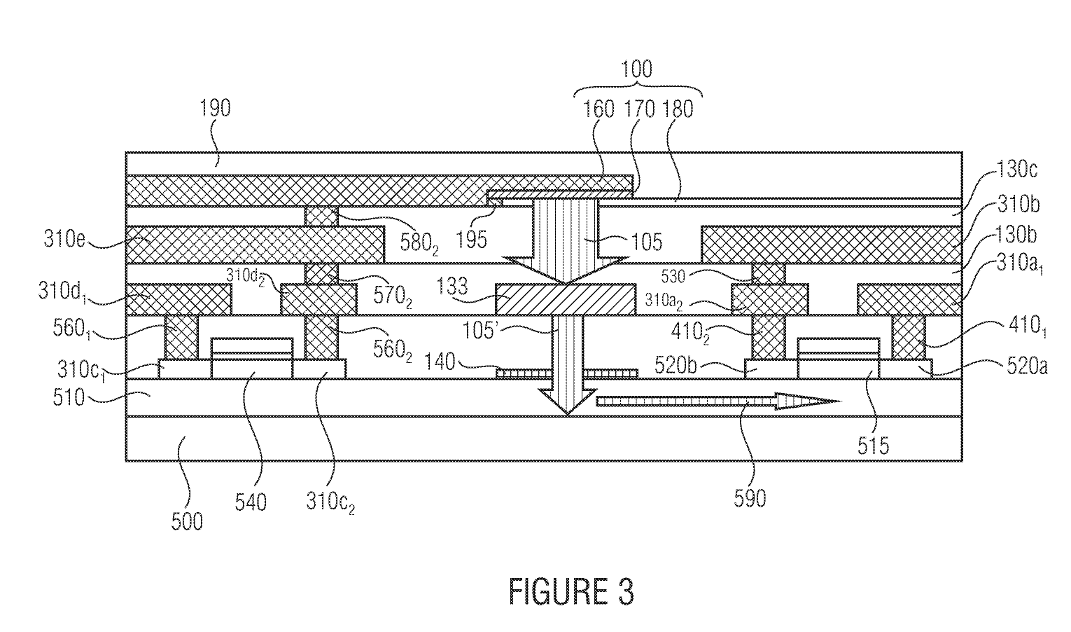

FIG. 3 shows an embodiment in which the OLED 100 indirectly radiates onto a photodetector 515 by using a buried dielectric, transparent layer 510 which serves as a light guide. The dielectric, transparent layer 510 (which may also be referred to as the buried layer) is deposited on a substrate 500 and serves as a foundation for the photodetector 515 and an OLED driver transistor 540. The photodetector 515 and the OLED driver transistor 540 are embedded into the ILD layer 130a, and the ILD layer 130a in turn has the IMD1 layer 130b and the IMD2 layer 130c deposited thereon. The IMD2 layer further serves as a substrate for the following OLED 100 comprising the transparent electrode 180, the organic layer sequence 170 and the second electrode 160, which again is embedded into a passivation 190, and the lateral isolation 195 provides an isolation between the transparent electrode 180 and the second electrode 160.

The photodetector 515 is electrically contacted via a first contact 520a and a second contact 520b. The first contact 520a is connected to a first part 310a₁ of the shielding plane 310a via a first bridge 410₁. The second contact 520b is connected to a second part 310a₂ of the shielding plane 310a via a second bridge 410₂, and the second part 310a₂ in turn is connected to the shielding plane 310b via a third bridge 530. Electrical contacting of the OLED driver transistor 540 is performed via a first part 310c₁ and via a second part 310c₂ of the shielding plane 310c. The first part 310c₁ is connected to a first part 310d₁ of the shielding plane 310d via a fifth bridge 560₁. The second part 310c₂ is connected to a second part 310d₂ of the shielding plane 310d via a sixth bridge 560₂. The second part 310d₂ in turn is connected to the shielding plane 310e via a seventh bridge 570₂, which shielding plane 310e in turn is electrically connected to the second electrode 160 of the OLED 100 via an eighth bridge 580₂.

As was previously described, the shielding planes 310b and 310e are embedded into the IMD2 layer 130c, and the shielding planes 310a and 310d are embedded into the IMD1 layer 130b. On the other hand, the ILD layer 130a comprises the parts 310c₁ and 310c₂ of the shielding plane 310c as well as the contacts 520a and 520b. The structures referred to as shielding planes in this context may each be implemented by portions of conductive metal planes of a CMOS structure, and further at least partly serve as lead structures by means of respective bridges or vias.

In this embodiment, the light signal 105 emitted by the OLED 100 as the bottom emitter impinges upon the reservoir 133, and the light signal 105′ emanating therefrom passes the optional filter 140 and impinges upon the incorporated dielectric, transparent layer 510 serving as an optical wave guide. The light signal 105′ generates, in the dielectric, transparent layer 510, a light signal 590 which propagates in the direction toward the photodetector 515 and generates an electrical signal there which is output via the contacts 520a and 520b. As was described above, the first contact 520a is connected to the first part 310a₁ of the shielding plane 310a, and the second contact 520b is connected to the shielding plane 310b, where the electrical signal is present as the output signal.

It is advantageous for the parts of the shielding planes 310a₁, 310a₂, 310b, 310c₁, 310c₂, 310d₁, 310d₂ and 310e to use conductive metal planes of the CMOS structure which are schematically depicted in FIG. 3, for example. The embodiment of FIG. 3 accordingly is based on an SOI-CMOS technology with a buried oxide layer which corresponds to the dielectric, transparent layer 510 and at the same time is utilized as an electrical isolator and light guide. In this manner, a high level of isolation voltage may be achieved despite possibly complex integration of emitter control and photodetector readout electronics. Both circuit parts are located on a chip such that they are completely isolated from each other. In order to achieve as high an absorption level as possible by the photodetector 515, the photodetector 515 should be selected to be accordingly large. An active layer which comprises silicon, for example, and is provided on the dielectric, transparent layer 510 should also be configured to be sufficiently thick so as to obtain a high probability of photon absorption. By way of example, a layer thickness ranging from about 200 nm to about 3 μm could be selected. The reservoir 133 and the optional filter may be implemented as was described in FIGS. 1 and 2.

The structures designated by reference numerals 310d₁, 310d₂, 310a₁ and 310a₂ in FIG. 3 may each be part of a first conductive metal plane (MET1) of a CMOS structure, the structures 310b and 310e may be parts of a second conductive metal plane (MET2), and the structure 160 may be part of a third conductive metal plane (MET3). In further embodiments, a complete evaluation and control unit is integrated instead of the OLED driving transistor 540.

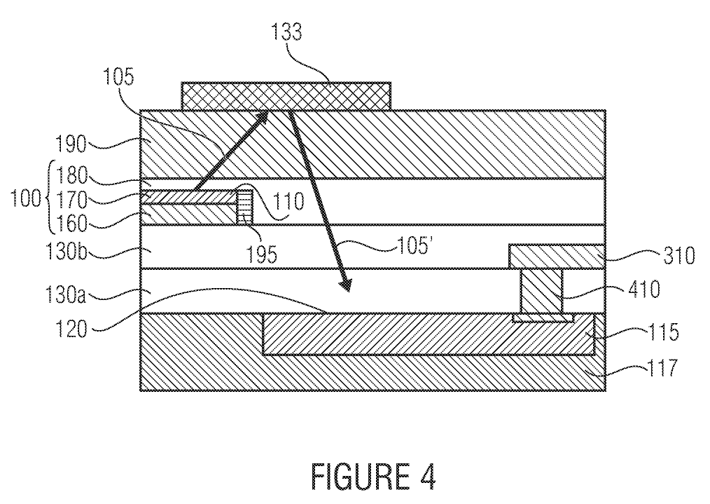

FIG. 4 shows an embodiment in which an OLED 100 which indirectly radiates onto the photodetector 115 is used as a top emitter. Just like in the embodiment illustrated in the context of FIG. 2, the photodetector 115 comprises that photodiode (formed by an existing pn junction) which is contacted via the contact 410 and is embedded into the p substrate 117. The contact 410 is connected to a conductive metal plane 310 of the CMOS structure. The conductive metal plane 310 is located within the IMD1 layer 130b, which in turn follows the ILD layer 130a.

The OLED 100 is applied onto the IMD1 layer 130b, a conductive metal plane (MET2), formed on the IMD1 layer 130b, serving as the lower electrode 160 onto which the organic layer sequence 170 and the transparent electrode 180 are applied. Eventually, the passivation 190, which comprises a transparent material, follows as a protection for the OLED as a top emitter 600. Here, too, the lateral isolation 195 provides an isolation between the transparent electrode 180 and the second electrode 160. The structures 310 and 160 serving for contacting may again be inherent parts of the CMOS structure, be configured as conductive metal planes, and additionally serve as shielding planes.

In this embodiment, the reservoir 133 is formed on the passivation 190. The reservoir 133 is arranged such that a light signal 105 from the OLED 100, which acts as a top emitter, impinges upon the reservoir 133, and that the emanating light signal 105′ is reflected onto the photodetector 115, i.e. the light signal 105 is radiated in the direction of the reservoir 133 and enters, as the light signal 105′, the photodiode 115 embedded into the p substrate 117. With this reflecting arrangement, the OLED 100 therefore radiates upward, i.e. in the direction of the passivation 190. As may be seen from FIG. 4, care should be taken, for a configuration, to ensure that the photodetector 115 is not covered by the shielding plane 310, so that as large a portion as possible of the light signal 105′ emanating from the reservoir 133 reaches the photodetector 115.

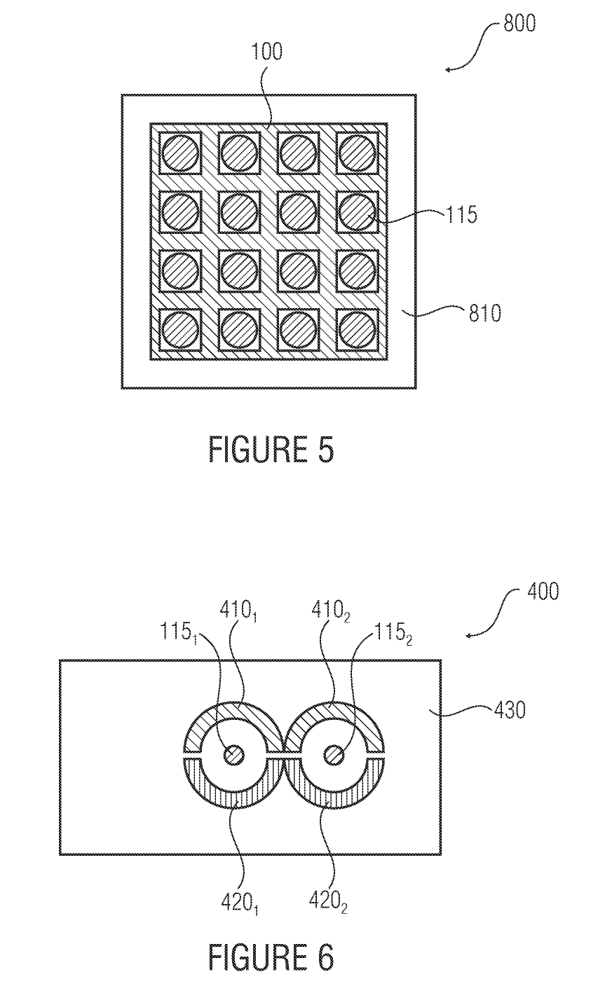

FIG. 5 shows a top view of a potential sensor arrangement 800 suited for a lab-on-chip application. A chip 810 has an OLED 100, which is implemented in a grid-shaped manner, and photodetectors (dashed areas) 115 located thereon in the respective gaps. Using photodetectors of different spectral sensitivities it is possible to establish, in a targeted manner, a specific portion of the emanating light signal 105′ (for example a portion which fluoresces with a specific color), and/or to detect its movement or change. The reservoir 133 may be implemented in the form of various pots at a surface of the sensor arrangement 800. In this case, the OLED 100 may be arranged as a top emitter. On the other hand, it is also possible for the reservoir 133 to be implemented as a channel system (for example within an oxide layer), in which case the OLED 100 may then be implemented as a bottom emitter.

In further embodiments, the OLED arranged in a grid-shaped manner is built from a multitude of OLEDs formed in a beam- or row-shaped manner. Thereby, in this sensor arrangement, a position of certain substances or objects on the chip may also be determined. By means of suitable OLEDs, which excite certain substances or components of liquids, concentrations of the specific substance may also be determined, with this sensor arrangement, in dependence on the position on the chip. Likewise, detection of temporal changes (e.g. of the concentration of a fluorescent substance) is possible.

FIG. 6 shows a top view of a potential sensor arrangement 400 suitable, in particular, as a fluorescence sensor. For example, the sensor arrangement 400 comprises two green OLEDs 410₁ and 410₂ as well as two blue OLEDs 420₁ and 420₂, which are part of a circuit 430. In this top view, two photodetectors 115₁ and 115₂ are arranged between the green OLEDs 410₁ and 410₂ as well as the blue OLEDs 420₁ and 420₂, so that ideally the green OLEDs 410₁ and 410₂ as well as the blue OLEDs 420₁ and 420₂ are equally spaced apart from the photodetectors 115₁ and 115₂. In further embodiments, further OLEDs and/or photodetectors may be provided. Likewise, combinations with further colors or utilization of OLEDs of other colors are possible. However, what proves advantageous in this context is that with further variants the various OLEDs are at an equal distance, as far as possible, from the photodetectors 115₁ and 115₂. By means of different colors, a fluorescence of substances may be excited, and the corresponding fluorescence radiation, which mostly is radiated off into a different wavelength, may be detected, and its temporal decay behavior (i.e. the decreasing intensity) may be measured. Thus, the substances under consideration may be detected by means of fluorescence. In this context it is advantageous for the photodetectors 115₁ and 115₂ to have increased sensitivity to the corresponding radiation caused by fluorescence. It is also possible to utilize part of the photodetectors, e.g. photodetector 115₂, in combination with part of the OLEDs, e.g. OLEDs 420₂ and 410₂, for reference measurement (e.g. without samples).

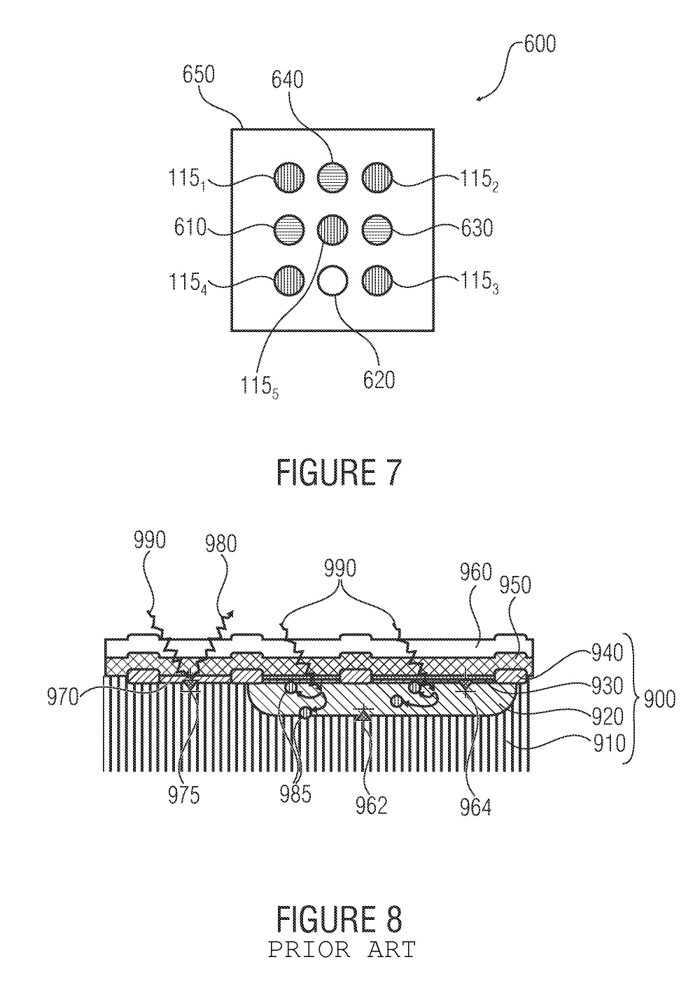

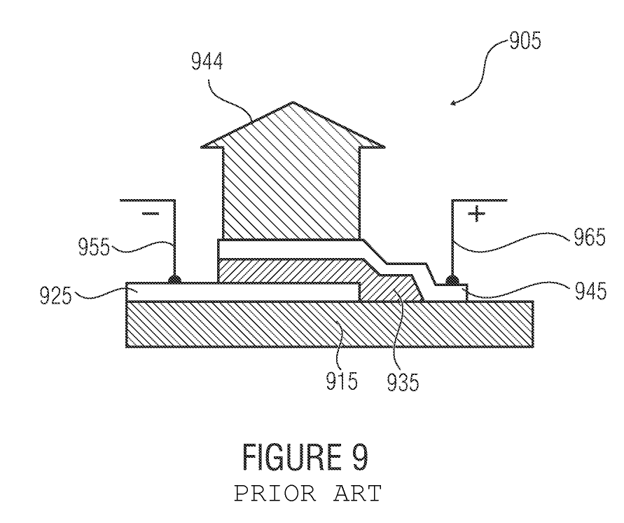

FIG. 7 shows a top view of a sensor arrangement 600 which is suitable, in particular, as a potential spectral/color sensor. This embodiment comprises four different OLEDs. A blue OLED 610, a green OLED 620, a red OLED 630, and a (near) infrared OLED 640 are arranged on a chip 650, which in this embodiment has a quadrangular shape, along with photodetectors 115₁, 115₂, 115₃, . . . . The photodetectors 115₁, 115₂, 115₃, . . . are symmetrically arranged on the chip 650; specifically, one photodetector is located at each corner and in the center, respectively. The different-colored OLEDs are arranged along the four side lengths of the chip 650, the blue OLED 610 being arranged on the left, the green OLED 620 being arranged at the bottom, the red OLED 630 being arranged on the right, and the (near) infrared OLED 640 being arranged at the top in the top view depicted here.

The choice of the arrangement of the OLEDs as well as the coloring is made freely, and in further embodiments, the OLEDs may be interchanged accordingly. Likewise, the number of OLEDs and their colors as well as the quadrangular shape of the chip 650 are only exemplary and may vary in further embodiments. However, it is advantageous for the photodetectors 115₁, 115₂, 115₃, . . . to be arranged as closely as possible to the various OLEDs so as to obtain a similar spectral sensitivity (sensitivity with regard to a spectral range) for all colors. However, mutual interference due to too small a distance should be ruled out. This embodiment may be used as a color sensor, i.e. different reflection properties of colored objects or substances with regard to colored light may be detected in a targeted manner, and therefore objects or substances may be distinguished by their colors. For this application it is advantageous, in particular, for OLEDs to be available in many colors. In contrast with the similar spectral sensitivity described, it may further be useful for specific applications for the photodetectors 115₁, 115₂, 115₃, . . . to have different spectral sensitivities. This may be effected, for example, by different realizations (such as the different diodes 975, 964 and 962 in FIG. 8). The various spectral sensitivities may be spectrally adjusted to the respective emitters, for example.

In the embodiments shown in FIGS. 5 to 7, the OLEDs and the photodetectors are offset in height, and the reservoir 133 has been omitted for clarity's sake.

The photodetectors 115 used, which are based on a CMOS process, may comprise different spectral characteristics, for example. In addition, it is possible to integrate organic light-emitting diodes as top emitters onto a CMOS metal layer as a bottom electrode. The photodetector 115 may be configured as any light-sensitive device occurring in CMOS structures, and it may comprise a photodiode or a phototransistor, for example.

In the lab-on-chip arrangement, the OLED often radiates upward (top emitter), i.e. in the direction of the passivation and, thus, in the opposite direction to the photodetector 115. The sample, the medium, or the reagent reflects the light, which may result in absorption, fluorescence or phosphorescence (static or time-resolved), and the sample, the medium or the reagent directs the light 105′ back to the photodetector 115 within the chip (within the substrate).

In addition to the light-emitting or light-detecting elements, control and evaluation electronics may be integrated into the CMOS chip (one example was shown in FIG. 3). Such an arrangement in turn may be part of a complex integrated circuit (IC), which may additionally comprise an optical coupler function as a microsystem. The geometric arrangement of the light emitter 100 and the detector 115 may be adjusted to the requirements of the measuring task. In this respect, the advantages of large-area deposition and patternability of the OLED 100 make themselves felt. What is more is that the area taken up by the OLED 100 in the background may be utilized by an active circuit which need not necessarily be linked to the OLED controller.

Further sensor geometries may be realized which are advantageous, for example, in applying fluorescence sensor technology. OLED emitters comprising different wavelengths may possibly be used here. Likewise, adjusting the spectral sensitivities of the photodetectors 115 to the emitter(s) 100 is possible via the choice of photodetectors 115. Embodiments thus describe, in particular, a microdisplay comprising an integrated photodetector matrix. Spectral sensitivity is associated with a sensitivity with regard to a spectral range and, thus, a filtering effect of the photodetectors is achieved at the same time.

The embodiments of the present invention which have been described may also be combined or extended, of course. For example, focussing of the light signal 105 may be performed by means of an optical system. This may be achieved, for example, by means of a lens or a mirror system, and would be advantageous in that the detector area 120 of the photodetector 115 may be selected to be accordingly smaller, and that nevertheless a sufficient quantity of light is obtained.

In addition, both analog and digitized signals may be used during operation. In order to effectively suppress external interference effects of, e.g., extraneous light, it may be advantageous to utilize a fixed clocking or a modulation.

Various aspects of the present invention may thus be summarized as follows:

Embodiments describe illumination of biological, chemical, and physical samples by organic semiconductors for illumination which are jointly integrated onto an active CMOS substrate, and by photodetectors 115—specifically, on a CMOS silicon chip within a matrix arrangement. The photodetector may comprise, e.g., an inorganic semiconductor as the active layer, e.g. as a CMOS photodetector 115. In embodiments, the CMOS photodetector 115 may comprise an appropriate design or barrier layer (materials, dopings, dimensional variations, etc.) so as to achieve a predetermined spectral filtering effect.

In further embodiments, the photodetector 115 comprises an organic photovoltaic cell. In addition, a filter may be realized by using organic materials.

Embodiments may thus be employed for absorption spectroscopy, for example by means of illumination using a white OLED and above-described filtering. The white OLED, or the white light emitted by the white OLED, may be generated, for example, using stacked light-emitting diodes, when the light of the individual OLEDs supplements itself to form white light due to superposition. Embodiments also describe utilization of OLED emitters comprising different wavelengths (different colors). It is also possible to use a pulsed OLED so as to measure, e.g., dynamics of the decay of the optical signals.

In further embodiments, photodiodes may be spatially arranged to measure the OLED brightness and to thereby allow homogeneity to be controlled.

In addition, it is possible to realize an array of cavities which represent microresonators, the liquid or the medium entering through an opening, and an increase in the absorption length being achieved by a standing wave. Thus, embodiments may be used as a spectral sensor or as a fluorescence sensor.

Information processing may also be achieved on the chip or on the substrate by means of active elements (a CMOS circuit, bipolar IC technology, etc.). Even though embodiments refer to or utilize CMOS structures, MOS technology or bipolar technology may generally also be used in a similar manner, i.e. embodiments do not require formation of a p- and an n-channel transistor.

With the OLED technology as an emitter, there is the possibility of a monolithically integrated approach, which both reduces the size of the devices and offers the possibility of integrating new functions. Likewise, multi-channel approaches may be integrated on a chip, in which case both the sample to be examined and/or its holder may also be realized on the chip (e.g. by means of a microchannel or a microchannel system).

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

What is claimed is:

1. A chip for analyzing a medium, comprising:
an organic light emitter for emitting a light signal;
a photodetector comprising a detector area;
a layer sequence separating the organic light emitter and the detector area, the layer sequence comprising a dielectric layer of a CMOS structure and serving as a substrate for the organic light emitter; and
a reservoir into which the medium may be introduced and which is implemented as a channel within the layer sequence,
wherein the organic light emitter and the photodetector may be optically coupled by means of a path of rays of the light signal, and the reservoir is arranged within the path of rays of the light signal.

2. The chip as claimed in claim 1, comprising further organic light emitters and/or further photodetectors.

3. The chip as claimed in claim 2, wherein the further photodetectors are implemented within a matrix arrangement.

4. The chip as claimed in claim 2, wherein the further photodetectors exhibit spectral sensitivities which differ from the spectral sensitivity of the photodetector.

5. The chip as claimed in claim 1, wherein the photodetector comprises an organic photovoltaic cell.

6. The chip as claimed in claim 1, wherein the photodetector comprises an inorganic semiconductor as an active layer.

7. The chip as claimed in claim 1, wherein the dielectric layer comprises an oxide layer of a CMOS structure.

8. The chip as claimed in claim 1, further comprising a filter which may be introduced into the path of rays of the light signal.

9. The chip as claimed in claim 8, wherein the filter comprises an organic material.

10. The chip as claimed in claim 8, wherein the filter may be introduced into the path of rays of the light signal between the reservoir and the photodetector.

11. The chip as claimed in claim 8, wherein the organic light emitter is configured to emit the light signal within a spectral range, and wherein the filter is implemented to filter out the spectral range and to allow a spectral range to which the photodetector is sensitive to pass.

12. The chip as claimed in claim 1, wherein the organic light emitter is implemented to emit the light signal within a spectral range, and wherein the photodetector is sensitive to incident light within a further spectral range, the spectral range deviating from the further spectral range.

13. The chip as claimed in claim 1, wherein the organic light emitter is implemented to emit white light.

14. The chip as claimed in claim 1, wherein the organic light emitter comprises a multitude of stacked light-emitting diodes, the stacked light-emitting diodes being implemented to emit light, so that a superposition of the light emitted by the stacked light-emitting diodes yields white light.

15. The chip as claimed in claim 1, wherein the organic light emitter is implemented to emit the light signal within a spectral range, and which further comprises a further organic light emitter, the further organic light emitter being implemented to emit light within a further spectral range, the spectral range differing from the further spectral range.

16. The chip as claimed in claim 1, wherein the organic light emitter is implemented to emit pulsed light signals.

17. The chip as claimed in claim 1, further comprising an evaluation and control unit, the evaluation and control unit being integrated on an identical substrate as the photodetector.

18. The chip as claimed in claim 2, wherein the further photodetectors are spatially arranged such as to measure a brightness of the organic light emitter.

19. The chip as claimed in claim 1, further comprising a microresonator, the microresonator being implemented to utilize the medium within the reservoir as an oscillation medium.

20. The chip as claimed in claim 1, wherein the reservoir is implemented to utilize a serum or blood as the medium.

21. The chip as claimed in claim 1, comprising a further reservoir and a further photodetector, the further reservoir being spatially separate from the reservoir and being optically couplable to the further photodetector, and the further photodetector comprising a spectral sensitivity which deviates from that of the photodetector.

22. Utilization of a chip for analyzing a medium, the chip comprising:
an organic light emitter for emitting a light signal;
a photodetector comprising a detector area;
a layer sequence separating the organic light emitter and the detector area, the layer sequence comprising a dielectric layer of a CMOS structure and serving as a substrate for the organic light emitter; and
a reservoir into which the medium may be introduced and which is implemented as a channel within the layer sequence,
wherein the organic light emitter and the photodetector may be optically coupled by means of a path of rays of the light signal, and the reservoir is arranged within the path of rays of the light signal,
as a lab-on-chip sensor, as a fluorescence sensor, or as a spectral sensor.

23. A method of manufacturing a chip for analyzing a medium, the method comprising:
implementing a photodetector comprising a detector area;
implementing a layer sequence on the detector area of the photodetector, the layer sequence comprising a dielectric layer of a CMOS structure;
implementing an organic light emitter for emitting a light signal, the layer sequence serving as a substrate for the organic light emitter, and the layer sequence being arranged between the organic light emitter and the detector area; and
implementing a reservoir into which the medium may be introduced and which is implemented as a channel within the layer sequence,
the organic light emitter and the photodetector being implemented such that a path of rays of the light signal optically couples the organic light emitter and the photodetector, and the reservoir being implemented within the path of rays of the light signal.
